(19) United States
(12) Patent Application Publication
(10) Pub. No.: US 2023/0292966 A1
(43) Pub. Date: Sep. 21, 2023

(54) MULTI-FUNCTIONAL WET VACUUM CLEANER

(71) Applicant: Sung Gye CHO, Gyeonggi-do (KR)

(72) Inventor: Sung Gye CHO, Gyeonggi-do (KR)

(21) Appl. No.: 18/004,377

(22) PCT Filed: May 3, 2021
(86) PCT No.: PCT/KR2021/005548

§ 371 Date: Jan. 5, 2023

(30) Foreign Application Priority Data
Jul. 6, 2020 (KR) 10-2020-0082718

(51) Int. Cl. A47L 7/00; A47L 5/36; A47L 9/00; A47L 9/12; A47L 9/22; A47L 9/24

(52) U.S. Cl. CPC A47L 7/0019; A47L 5/365; A47L 9/009; A47L 9/12; A47L 9/22; A47L 9/242; A47L 9/0072; B23Q 11/1069

(57) ABSTRACT

The present invention relates to a multi-functional wet vacuum cleaner that is mounted on a waste oil storage drum to absorb, collect, and remove waste cutting oil of machine tools, hydraulic oil residue of hydraulic devices, and post oil work residue generated during the production of metal products such as bolts, screws, nails, and the like. Also, the cleaner exhibits the ability to clean large volumes of waste. The multi-functional wet vacuum cleaner is characterized by comprising a cover unit to which a suction motor is mounted and a body unit which has an accommodation space. The body unit includes: a suction pipe connection part formed at the upper end of one side of the accommodation space; an opening formed on the bottom surface of the accommodation space; a guide pipe extending a certain length downward from the circumference of the opening; and a connection pipe installed such that one end is connected to the suction pipe connection part inside the accommodation space and the other end passes through the opening and protrudes further than an end portion of the bottom surface of the guide pipe, the connection pipe having a gap to allow air to flow into the opening.

### TECHNICAL FIELD

The present invention relates to a multi-functional wet vacuum cleaner, and more specifically, to a multi-functional wet vacuum cleaner that is mounted on a waste oil storage drum to absorb, collect, and remove waste cutting oil of machine tools, hydraulic oil residue of hydraulic devices, and residues from oil generated during the production of metal products such as bolts, screws, nails, and the likes, and has ability to clean a large volume of wastes.

### BACKGROUND ART

A conventional wet vacuum cleaner has a disadvantage in that it is inconvenient since a user has to clean while emptying the cleaner several times due to its small capacity when the cleaner performs wet cleaning with respect to waste cutting oil of machine tools, hydraulic oil residue of hydraulic devices, and residues from oil (hereinafter, called ‘waste oil’) generated during the production of metal products such as bolts, screws, nails, and the likes.

Therefore, in order to solve the above problem, as illustrated in FIG. 1, a cleaning method using a vacuum induction device 20 and an air compressor 30 has been proposed.

According to the cleaning method, a suction unit 21 of the vacuum induction device 20 is mounted in an upper opening 12 of a waste oil storage drum 10, an output hose 31 of an air compressor 30 is connected to a supply unit 22 of the vacuum induction device 20, and a suction pipe 14 is connected to an upper inlet 13 of the waste oil storage drum 10.

Moreover, in a case in which the air compressor 30 is operated, high-pressure air is injected through the output hose 31, and the injected high-pressure air is discharged to an outlet 23 by an internal structure of the vacuum induction device 20, so that the suction unit 21 sucks the air.

As the air in the waste oil storage drum 10 is discharged through the outlet 23 by the suction operation of the suction unit 21, the inside of the waste oil storage drum 10 is changed into a vacuum state while the pressure lowers.

As described above, when the inside of the waste oil storage drum 10 is in a vacuum state, a suction pipe 14 connected to the inlet 13 performs a suction operation due to a pressure difference with the outside to suck waste oil 41 accommodated on a tray 40.

Here, the tray 40 is a container that is integrally mounted on the machine tool mentioned above to store the discharged waste oil, and the suction pipe 14 is a pipe that a user holds with the hand to suck the waste oil stored in the tray 40.

Accordingly, the waste oil 41 sucked through the suction pipe 14 is introduced and stored into the waste oil storage drum 10 through the inlet 13.

The conventional art has improved cleaning ability. However, the conventional art increases additional costs due to the use of the air compressor 30 or has a limitation in carrying and storing. Moreover, the conventional art has additional disadvantage in that the vacuum induction device 20 has output loss due to the air discharged to the outside and it causes a lack of capacity of the air compressor 30.

### DISCLOSURE

### Technical Problem

The present invention has been made to solve the above-mentioned problems occurring in the prior arts, and it is an object of the present invention to provide a multi-functional wet vacuum cleaner that is mounted on a waste oil storage drum to absorb, collect, and remove waste cutting oil of machine tools, hydraulic oil residue of hydraulic devices, and residues from oil generated during the production of metal products such as bolts, screws, nails, and the likes, and has ability to clean a large volume of wastes.

It is another object of the present invention is to provide a multi-functional wet vacuum cleaner capable of performing the function of a general wet vacuum cleaner by further including a movable support container on a lower portion thereof.

### Technical Solution

To accomplish the above-mentioned objects, according to the present invention, there is provided a multi-functional wet vacuum cleaner including a cover unit on which a suction motor is mounted, and a body unit having an accommodation space.

The body unit includes: a suction pipe connection part formed at an upper end of one side of the accommodation space; an opening formed in the bottom surface of the accommodation space; a guide pipe formed to extend downward from the circumference of the opening to a predetermined length; and a connection pipe mounted such that one end is connected to the suction pipe connection part inside the accommodation space and the other end passes through the opening to further protrude out of the end portion of the bottom surface of the guide pipe, and having a gap to allow air to pass through the opening.

Moreover, according to the present invention, a suction pipe for sucking waste oil is connected to the suction pipe connection part protruding out of the body unit.

Furthermore, according to the present invention, the cover unit includes: a suction motor detachably coupled to the body unit to generate a suction force by rotating an impeller; a suction hole formed at the front of the impeller; a support protruding forward from the suction hole to support a float seated therein and a filter mounted outside the support; the float movably inserted into the support to close the suction hole when being risen; the filter forcedly fit to the outside of the support; a fixing part configured to fix the filter to the support; and a handle formed on an outer upper portion of the cover unit.

Additionally, according to the present invention, the multi-functional wet vacuum cleaner further includes a movable support container having an upper end on which the vacuum cleaner is detachably mounted.

The movable support container includes: an accommodation part formed therein; a retaining protrusion for allowing the bottom surface of the vacuum cleaner to be seated on the circumference of the upper end of the accommodation part; second fastening parts formed at both ends thereof so that the movable support container is sealably coupled to the vacuum cleaner; and wheels formed on the bottom surface thereof.

In addition, according to the present invention, a corrugated pipe is further mounted on the guide pipe.

### ADVANTAGEOUS EFFECTS

As described above, the multi-functional wet vacuum cleaner according to the present invention is mounted on a waste oil storage drum to absorb, collect, and remove waste cutting oil of machine tools, hydraulic oil residue of hydraulic devices, and residues from oil generated during the production of metal products such as bolts, screws, nails, and the likes, and has ability to clean a large volume of wastes.

Additionally, the multi-functional wet vacuum cleaner can perform the function of a general wet vacuum cleaner by further including a movable support container on a lower portion thereof.

### DESCRIPTION OF DRAWINGS

FIG. 1 is a diagram of a configuration of a conventional wet vacuum cleaner.

FIG. 2 is a perspective view of a multi-functional wet vacuum cleaner according to an embodiment of the present invention.

FIG. 3 is an exploded perspective view of the multi-functional wet vacuum cleaner according to the embodiment of the present invention.

FIG. 4 is a cross-sectional side view of essential parts illustrating a used state according to an embodiment of the present invention.

FIGS. 5 and 6 are enlarged views of the essential parts of FIG. 4.

FIG. 7 is a view illustrating a sealing member according to another embodiment of the present invention.

FIG. 8 is a perspective view according to another embodiment of the present invention;

FIG. 9 is an exploded perspective view of FIG. 7.

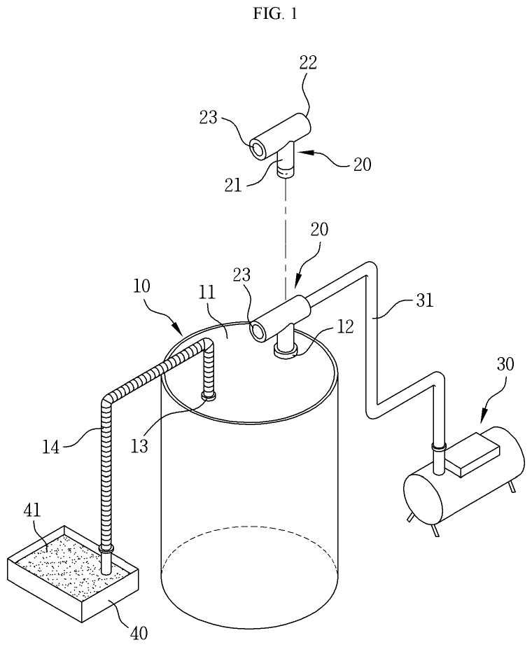

### MODE FOR INVENTION

Hereinafter, preferred embodiments of the present invention will be described in more detail with reference to the accompanying drawings.

In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

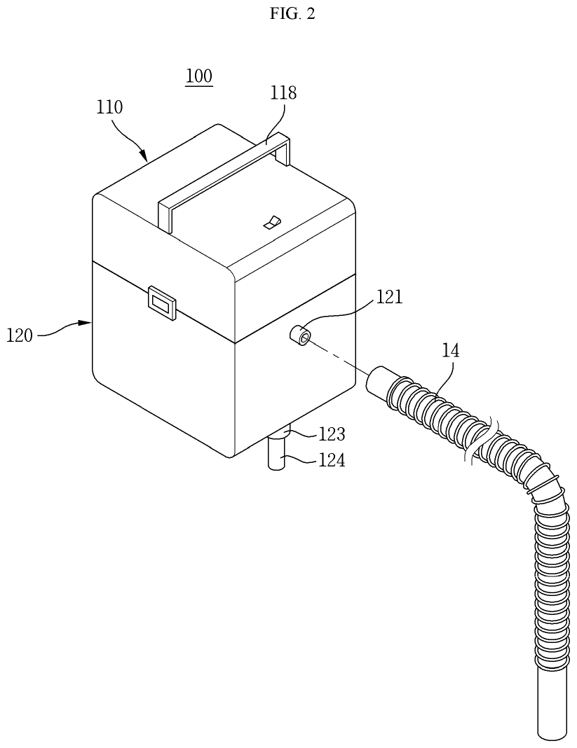

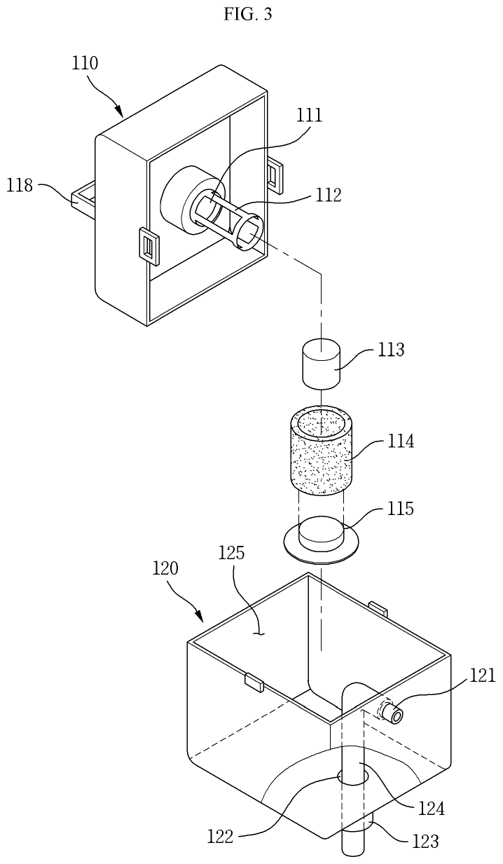

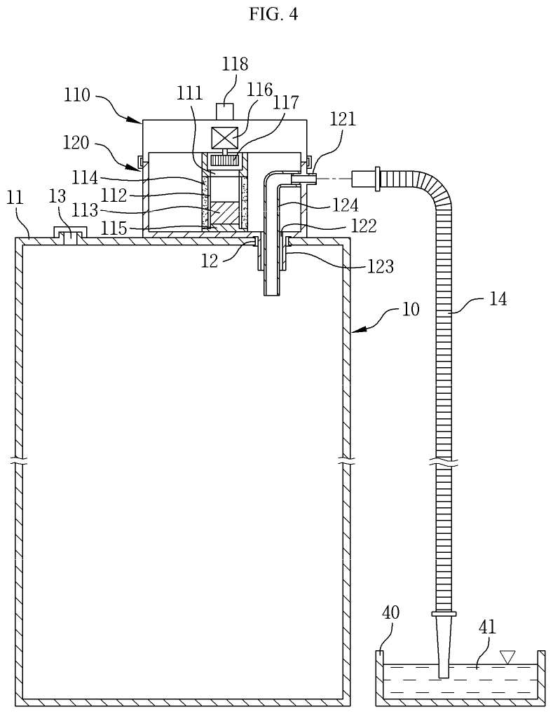

FIG. 2 is a perspective view of a multi-functional wet vacuum cleaner according to an embodiment of the present invention, FIG. 3 is an exploded perspective view of the multi-functional wet vacuum cleaner according to the embodiment of the present invention, and FIG. 4 is a cross-sectional side view of essential parts illustrating a used state according to an embodiment of the present invention.

As illustrated, the wet vacuum cleaner 100 according to the present invention includes:

a cover unit 100 on which a suction motor 111 is mounted; and a body unit 120 having an accommodation space 125.

The cover unit 110 includes: a suction motor 116 detachably coupled to the body unit 120 to generate a suction force by rotating an impeller 117; a suction hole 111 formed at the front of the impeller 117; a support 112 protruding forward from the suction hole 111 to support a float 113 seated therein and a filter 114 mounted outside the support; the float 113 movably inserted into the support 112 to close the suction hole 117 when being risen; the filter 114 forcedly fit to the outside of the support 112; a fixing part 115 configured to fix the filter 114 to the support 114; and a handle 118 formed on an outer upper portion of the cover unit.

The body unit part 120 includes: a suction pipe connection part 121 formed at an upper end of one side of the accommodation space 125; an opening 122 formed in the bottom surface of the accommodation space 125; a guide pipe 123 formed to extend downward from the circumference of the opening 122 to a predetermined length; and a connection pipe 124 mounted such that one end is connected to the suction pipe connection part 121 inside the accommodation space 125 and the other end passes through the opening 122 to further protrude out of the end portion of the bottom surface of the guide pipe 123, and having a gap to allow air to pass through the opening 122.

In addition, the suction pipe 14 for sucking waste oil 41 is connected to the suction pipe connection part 121 protruding out of the body unit 120.

Hereinafter, the operation of the wet vacuum cleaner 100 according to the present invention will be described.

First, the float 113 is inserted into the support 112 of the cover unit 110, and the filter 114 is mounted on the outside, and then the fixing part 115 is fastened to the lower portion of the support 112.

Thereafter, the cover unit 110 is coupled to the body unit 120.

When the assembly operation of the vacuum cleaner 100 is completed, the body unit 110 is placed on the upper end of the waste oil storage drum 10 to store waste oil.

In this instance, the guide tube 123 of the bottom surface of the body unit 120 is inserted into the opening 12 formed in the upper end of the waste oil storage drum 10 as illustrated in FIG. 3.

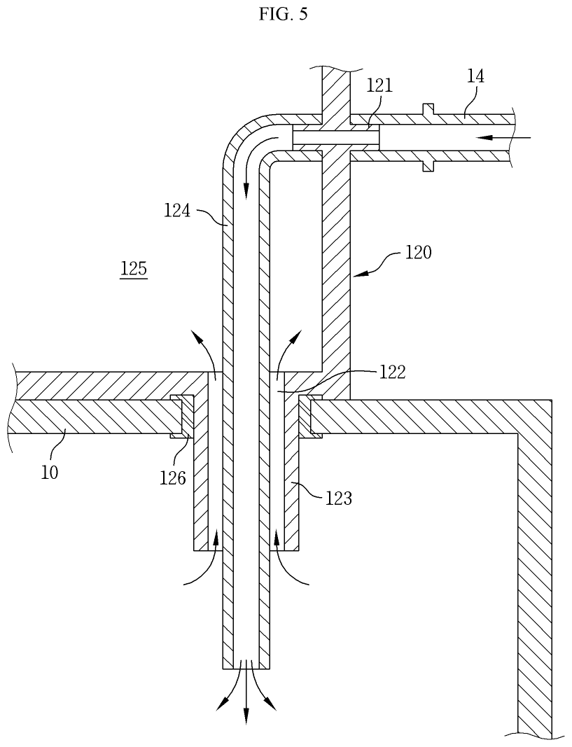

Here, as illustrated in FIG. 5, a sealing member 126 may be further inserted into the opening 12 of the waste oil storage drum 10 to further increase the sealing force between the opening 12 and the guide tube 123.

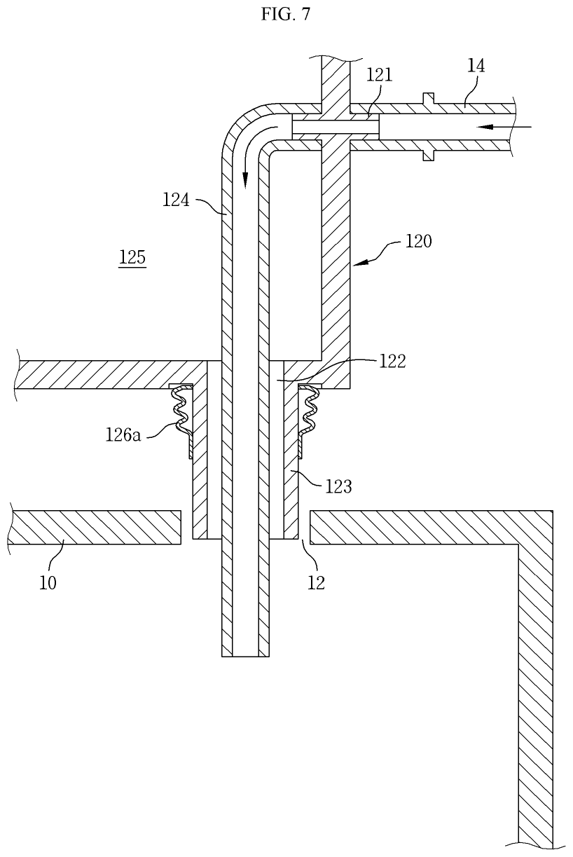

As illustrated in FIG. 7, the sealing member 126 may be a corrugated tube 126a formed of a rubber material mounted on the guide tube 123.

As described above, when the guide pipe 123 is completely mounted, the suction pipe 14 is connected to the suction pipe connection part 121.

When the preparation is completed, the vacuum cleaner 100 is operated. When the vacuum cleaner 100 is operated, the suction motor 116 is driven, and the impeller 117 is rotated interlocking with the suction motor.

The air inside the accommodation space 125 is introduced into the suction hole 111 through the filter 114 by the rotation of the impeller 117, and is discharged to the outside of the vacuum cleaner 100 through an outlet that is not illustrated.

As illustrated in FIG. 5, the suction operation is performed in such a way as to suck the internal air of the waste oil storage drum 10 through the opening 122 which is a gap between the guide pipe 123 and the connection pipe 124.

The internal pressure of the waste oil storage drum 10 is lowered by the outflow of the air to the opening 122, and the suction pipe 14 connected to the suction pipe connection part 121 performs a suction operation of sucking external air due to a pressure difference between internal pressure and external pressure.

In this instance, the user can clean the waste oil 41 on the tray 40 using the suction pipe 14.

Accordingly, the waste oil 41 sucked through the suction pipe 14 is introduced into the waste oil storage drum 10 through the connection pipe 124.

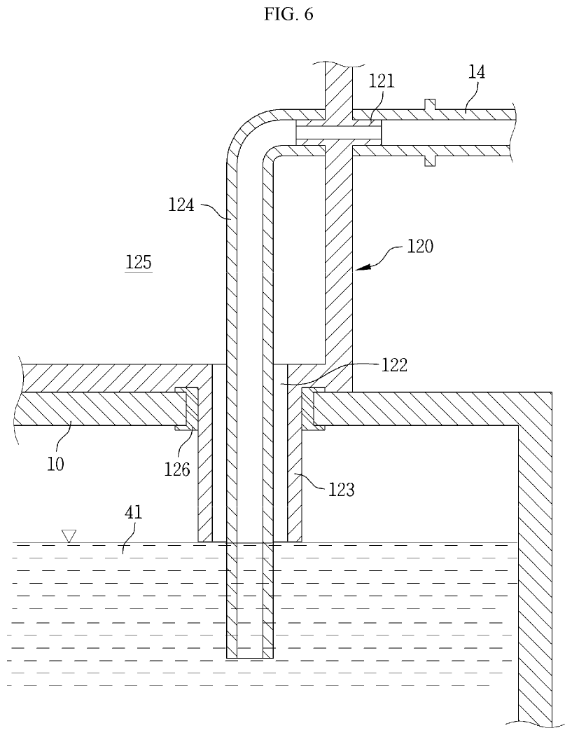

As illustrated in FIG. 6, when the waste oil 41 is introduced and stored into the waste oil storage drum 10 and the water level of the waste oil 41 reaches the end of the guide pipe 123, the introduction of air is closed and the internal pressure of the accommodation space 125 of the vacuum cleaner 100 is increased. Then, the vacuum cleaner 100 senses the increase of the internal pressure (by a pressure sensor which is not illustrated) and stops the driving of the suction motor 116.

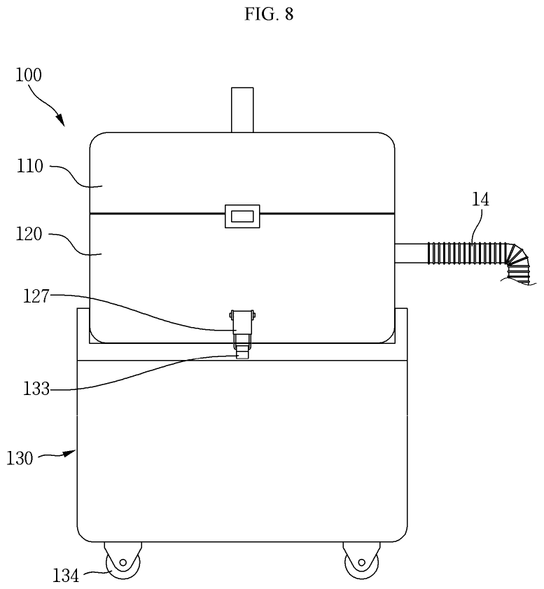

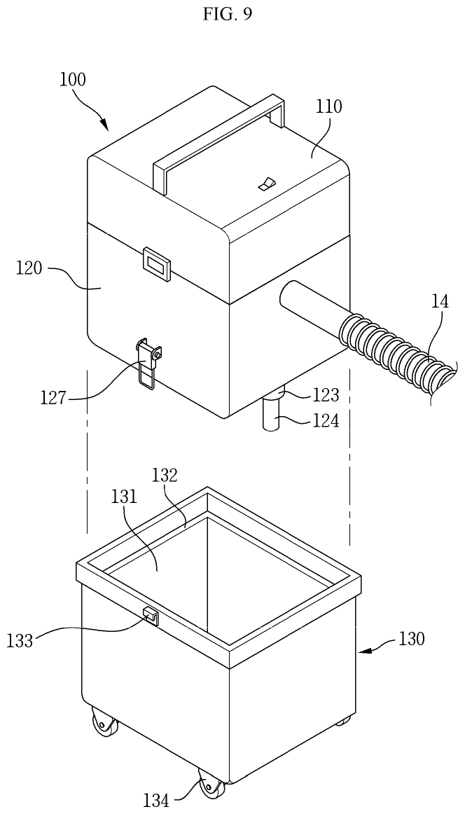

FIGS. 8 and 9 are views illustrating a multi-functional wet vacuum cleaner according to another embodiment of the present invention. The same components as those of the above-described embodiment will be denoted by the same reference numerals, and repeated descriptions will be omitted.

According to another embodiment of the present invention, multi-functional wet vacuum cleaner further includes a movable support container 130.

The movable support container 130 includes: an accommodation part 131 formed therein; a retaining protrusion 132 for allowing the bottom surface of the vacuum cleaner 100 to be seated on the circumference of the upper end of the accommodation part 131; second fastening parts 133 formed at both ends thereof so that the movable support container is sealably coupled to the vacuum cleaner 100; and wheels 134 formed on the bottom surface thereof.

In a case in which the vacuum cleaner 100 is detachably mounted on the upper end of the movable support container, when the bottom surface of the body unit 120 of the vacuum cleaner 100 is caught to the retaining protrusion 132, the second fastening part 133 is connected to the first fastening part 127 formed on the side surface of the vacuum cleaner 120.

Therefore, the vacuum cleaner 100 is integrally fixed to the movable support container 130, and in this instance, the vacuum cleaner 100 according to the present invention is not only used in a state in which the vacuum cleaner is mounted on the upper end of the waste oil storage drum 10, but also comes into common use as a general wet vacuum cleaner and is movably used through the wheels 134.

As described above, the multi-functional wet vacuum cleaner according to the present invention is mounted on a waste oil storage drum to absorb, collect, and remove waste cutting oil of machine tools, hydraulic oil residue of hydraulic devices, and residues from oil generated during the production of metal products such as bolts, screws, nails, and the likes, and has ability to clean a large volume of wastes.

In addition, the multi-functional wet vacuum cleaner can perform the function of a general wet vacuum cleaner by further including a movable support container on a lower portion thereof.

While the present disclosure have been described with reference to particular details such as specific elements, it will be understood by those skilled in the art that the present disclosure belongs that the present disclosure is not limited to the embodiments and various modifications and changes may be made from the description.

1. A multi-functional wet vacuum cleaner comprising a cover unit on which a suction motor is mounted, and a body unit having an accommodation space,
wherein the body unit comprises: a suction pipe connection part formed at an upper end of one side of the accommodation space; an opening formed in the bottom surface of the accommodation space; a guide pipe formed to extend downward from the circumference of the opening to a predetermined length; and a connection pipe mounted such that one end is connected to the suction pipe connection part inside the accommodation space and the other end passes through the opening to further protrude out of the end portion of the bottom surface of the guide pipe, and having a gap to allow air to pass through the opening.

2. The multi-functional wet vacuum cleaner according to claim 1, wherein a suction pipe for sucking waste oil is connected to the suction pipe connection part protruding out of the body unit.

3. The multi-functional wet vacuum cleaner according to claim 1, wherein the cover unit comprises: a suction motor detachably coupled to the body unit to generate a suction force by rotating an impeller; a suction hole formed at the front of the impeller; a support protruding forward from the suction hole to support a float seated therein and a filter mounted outside the support; the float movably inserted into the support to close the suction hole when being risen; the filter forcedly fit to the outside of the support; a fixing part configured to fix the filter to the support; and a handle formed on an outer upper portion of the cover unit.

4. The multi-functional wet vacuum cleaner according to claim 1, further comprising a movable support container having an upper end on which the vacuum cleaner is detachably mounted,
wherein the movable support container comprises: an accommodation part formed therein; a retaining protrusion for allowing the bottom surface of the vacuum cleaner to be seated on the circumference of the upper end of the accommodation part;
second fastening parts formed at both ends thereof so that the movable support container is sealably coupled to the vacuum cleaner; and wheels formed on the bottom surface thereof.

5. The multi-functional wet vacuum cleaner according to claim 1, wherein a corrugated pipe is further mounted on the guide pipe.
